(19) United States
(12) Patent Application Publication
(10) Pub. No.: US 2006/0199730 A1
(43) Pub. Date: Sep. 7, 2006

(54) Composition and method for improving density and hardness of fluid bed catalysts

(76) Inventors: Michael J. Seely, Naperville, IL (US); Christos Paparizos, Willoughby, OH (US); Dev D. Suresh, Hudson, OH (US); Maria S. Friedrich, Lyndhurst, OH (US); David A. Orndoff, Windsor, OH (US)

Correspondence Address: Gloria O'Bannon;Innovene, Inc., Suite 2500, 200 East Randolph St., Chicago, IL, 60601, US

(21) Appl. No.: 11/070,699

(22) Filed: Mar. 2, 2005

(51) Int. Cl. B01J 21/08

(52) U.S. Cl. 502/246

(57) ABSTRACT

A catalyst composition for the oxidation and ammoxidation of hydrocarbons comprising a plurality of silica sol particles with different average particle sizes, and a complex of metal catalytic oxides having the formula:
AₐB_{b}C_{c}Bi_{d}MOₑOₓ, wherein (i) A is one or more of Li, Na, K, Cs, Rb, In, and TI B is one or more of Ni, Mn, Co, Mg, Ca, and Zn C is one or more of Fe, Cr, Ce, Cu, V, W, Sb, Sn, Ge, P, B, Ga, Te, Nb, and Ta, a is 0.0-1.0 b is 0.0-12.0 c is 1.0-12.0 d is 0.0-2.0 e is 12.0-14.0; or
AₐB_{b}Sb₁₂Oₓ, wherein (ii) A is one or more of Fe, Cr, Ce, V, U, Sn, Ti, Ga, and Nb B is one or more of Mo, W, Co, Cu, Te, Bi, Ni, Ca, and Ta a is 0.1-16 b is 0.0-12.0. In both (i) and (ii), the value of x depends on the oxidation state of the metals used. Furthermore, a process for producing said ammoxidation catalyst is disclosed.

### CROSS-REFERENCE TO RELATED APPLICATIONS

None.

### FIELD OF THE INVENTION

This invention relates to an improved catalyst and method to decrease the attrition (i.e. improve the attrition resistance) of silica supported fluid bed catalysts, in particular, for the oxidation and ammoxidation of olefins and paraffins.

### BACKGROUND OF THE INVENTION

It is well known in the art of fluid bed oxidation and ammoxidation catalysis that silica is a preferred binder that provides the necessary hardness for fluid bed catalysts. When acrylonitrile is produced by ammoxidation, the ammoxidation is conducted using a fluidized-bed reactor. In an ammoxidation process, propylene, oxygen, and ammonia are catalytically converted directly to acrylonitrile using a fluidized-bed reactor operated at temperatures between 400° C. and 500° C. and gauge pressures between 0.3 and 2 bar. With respect to a catalyst for the ammoxidation using a fluidized bed reactor, it is necessary for the ammoxidation catalyst to have a high attrition resistance. A catalyst should exhibit high attrition resistance to reduce catalyst losses resulting from generation and loss of catalyst “fines”. The generation of “fines” will also decrease the rate of filtration. Catalyst losses also have a negative economic impact resulting from its loss from a reactor. There is often a trade-off between catalyst performance and the rate of catalyst separation. Catalyst filtration rate and attrition resistance are largely functions of particle size, particle shape, pore volume, pore size distribution, surface area and raw material source. Thus, an ammoxidation catalyst generally has a structure where a compound metal oxide is supported on silica particles to provide attrition resistance. The attrition of a working silica supported catalyst in a fluid bed reactor is low, and the loss due to attrition can be easily compensated with periodic addition of small amounts of fresh catalyst. However, additional methods to minimize the attrition in commercial operations are preferable. Fluid bed oxidation and ammoxidation catalysts are usually prepared by mixing the active phase portion, usually containing transition and other metal oxides, with silica sol. This aqueous slurry is spray dried and further calcined at desired temperatures to get the final product.

### SUMMARY OF THE INVENTION

This invention is directed to a catalyst composition for the oxidation and ammoxidation of hydrocarbons. The catalyst comprises a plurality of silica sol particles with different average particle sizes, and a complex of metal catalytic oxides having the formula:
AₐB_{b}C_{c}Bi_{d}MOₑOₓ, wherein (i)
A is one or more of Li, Na, K, Cs, Rb, In, and TI
B is one or more of Ni, Mn, Co, Mg, Ca, and Zn
C is one or more of Fe, Cr, Ce, Cu, V, W, Sb, Sn, Ge, P, B, Ga, Te, Nb, and Ta,
a is 0.0-1.0
b is 0.0-12.0
c is 1.0-12.0
d is 0.0-2.0
e is 12.0-14.0; or
(ii) AₐB_{b}Sb₁₂Oₓ, wherein
A is one or more of Fe, Cr, Ce, V, U, Sn, Ti, Ga, and Nb
B is one or more of Mo, W, Co, Cu, Te, Bi, Ni, Ca, and Ta
a is 0.1-16
b is 0.0-12.0.
   In both (i) and (ii), the value of x depends on the oxidation state of the metals used.

This invention is also directed to a process for producing an ammoxidation catalyst. The process comprises mixing an aqueous slurry of a plurality of silica sol particles with different average particle sizes and a complex of metal catalytic oxides wherein said metal is selected from the group consisting of: Li, Na, K, Cs, Rb, In, TI, Ni, Mn, Co, Mg, Ca, Zn, Fe, Cr, Ce, Cu, V, W, Sb, Sn, Ge, P, B, Ga, Te, Nb, Ta, U, Ti, Mo, W, and Bi; drying and calcining said mixture to produce said ammoxidation catalyst.

The invention shall be described for the purposes of illustration only in connection with certain embodiments. However, it is recognized that various changes, additions, improvements, and modifications to the illustrated embodiments may be made by those persons skilled in the art, all falling within the scope and spirit of the invention.

### DETAILED DESCRIPTION OF THE INVENTION

This invention discloses using a mixture of silica sols of two different silica particle sizes (more specifically silica sols of different average particle sizes), instead of a uniform single sol of single size (or a very narrow size range) silica particle. A “sol” is a stable dispersion of particles. In other words, the particles are small enough that gravity doesn't cause them to settle, but large enough not to pass through a membrane, allowing other molecules to pass freely. Preferably, the mixture should contain a higher percentage of the sol with bigger silica particles and a lower percentage of the sol with smaller silica particles. The mixing of the large and small particles provides the closest packing of silica particles, and this improves density of the final catalyst. This subsequently improves the hardness of the catalyst and decreases catalyst loss due to attrition. If the average particle size of the silica sol is too large, the manufactured catalyst will have poor anti-abrasion strength. If the average particle size of the silica sol is too small, the surface area of the manufactured catalyst will be increased and the catalyst will exhibit reduced selectivity. Typically, the average particle size diameter is between about 15 nm and about 50 nm.

The active phase compositions of oxidation and ammoxidation catalysts are well known in the art. For particular procedures for manufacturing the catalysts, see U.S. Pat. Nos. 5,093,299; 4,863,891 and 4,766,232, herein incorporated by reference. By way of illustration included are active phase compositions of the following formula:
AₐB_{b}C_{c}D_{d}MOₑOₓ, where:
A: One or more of the following elements→Li, Na, K, Cs, Rb, In, TI, or mixtures thereof
B: One or more of the following elements→Ni, Mn, Co, Mg, Ca, Zn, or mixtures thereof
C: One or more of the following elements→Fe, Cr, Ce, Cu, V, W, Sb, Sn, Ge, P, B, Ga, Te, Nb,Ta, or mixtures thereof
a: 0.01-1.0,
b,c,d independently are: 1.0-12.0
e: 12.0-14.0
the value of x depends on the oxidation state of elements used
D is not defined. No mention of Bi
-OR-
   AₐB_{b}Sb₁₂Oₓ, where:
A: One or more of the following elements→Fe, Cr, Ce, V, U, Sn, Ti, Ga, Nb, or mixtures thereof
B: One or more of the following elements→Mo, W, Co, Cu, Te, Bi, Ni, Ca, Ta, or mixtures thereof
a: 0.1-16
b: 0.0-12.0
the value of x depends on the oxidation state of elements used.
   Specific examples of catalyst compositions include the following:
60% Li_{0.1}Cs_{0.1}Ni_{6.2}Mg_{2.5}Fe_{2.0}Bi_{0.5}Cr_{0.5}Mo_{13.6}+40% SiO₂
55% K_{0.1}TI_{0.1}Co_{6.2}Ni_{2.5}Fe_{2.0}Bi_{0.5}Cr_{0.5}Mo_{13.6}+45% SiO₂
50% K_{0.1}Cs_{0.05}CO_{4.5}Ni_{2.5}Fe_{2.0}Mn_{1.0}Bi_{1.0}Cr_{0.5}Mo_{13.6}+50% SiO₂
50% K_{0.1}Co_{4.5}Ni_{2.5}Fe_{3.0}Bi_{1.0}P_{0.5}Mo_{12.0}+50% SiO₂
60% Cu_{4.5}Sb_{2.5}V_{3.0}W_{1.2}Sn_{1.5}Mo_{12.0}+40% SiO₂
60% Cu_{4.0}Mo_{0.5}Fe_{10.0}W_{0.5}Te_{1.8}V_{0.5}Cr_{0.5}Sb_{12.0}+40% SiO₂
70% Cu_{4.0}Mo_{0.5}Fe_{10.0}W_{0.5}Te_{1.8}V_{0.5} Cr_{0.5}Sb_{12.0}+30% SiO₂
80% Ti_{0.4}Mo_{0.1}Fe_{0.4}Sn_{0.4}V_{7.5}Sb_{12.0}+20% SiO₂
80% Ti_{2.0}Mo_{8.0}Te_{2.0}Nb_{4.0}V_{8.0}Sb_{12.0}+20% SiO₂

The catalysts of the present invention may be prepared by any of the numerous methods of catalyst preparation which are known to those of skill in the art. For example, the catalyst may be manufactured by co-precipitating the various ingredients. The co-precipitating mass may then be dried and ground to an appropriate size. Alternatively, the co-precipitated material may be slurried and spray dried in accordance with conventional techniques. The catalyst may be extruded as pellets or formed into spears in oil as is well known in the art. Alternatively, the catalyst components may be mixed with a support in the form of the slurry followed by drying or they may be impregnated on silica or other supports.

The “A” component of the catalyst (i.e. one or more of Li, Na, K, Cs, Rb, In, TI, Fe, Cr, Ce, V, U, Sn, Ti, Ga, Nb or mixtures thereof) may be derived from any suitable source. Typically, the “B” and “C” components of the catalyst (i.e. one or more of Ni, Mn, Co, Mg, Ca, Zn, Mo, W, Co, Cu, Te, Bi, Ni, Ca, Ta or mixtures thereof (the “B” components) or Fe, Cr, Ce, Cu, V, W, Sb, Sn, Ge, P, B, Ga, Te, Nb,Ta, or mixtures thereof (the “C” components)) may be introduced into the catalyst as an oxide or as a salt which upon calcination will yield the oxide. For example, cobalt, nickel and magnesium may be introduced into the catalyst using nitrate salts. Additionally, magnesium may be introduced into the catalyst as an insoluble carbonate or hydroxide which upon heat treating results in an oxide. Phosphorus may be introduced in the catalyst as an alkaline metal salt or alkaline earth metal salt or the ammonium salt but is preferably introduced as phosphoric acid. Calcium may be added via pre-formation of calcium molybdate or by impregnation or by other means known in the art.

Bismuth may be introduced into the catalyst as an oxide or as a salt which upon calcination will yield the oxide. The water soluble salts which are easily dispersed but form stable oxides upon heat treating are preferred. An especially preferred source for introducing bismuth is bismuth nitrate which has been dissolved in a solution of nitric acid.

The molybdenum component of the catalyst may be introduced from any molybdenum oxide such as dioxide, trioxide, pentoxide or heptaoxide. However, it is preferred that a hydrolizable or decomposable molybdenum salt be utilized as the source of the molybdenum. The most preferred starting material is ammonium heptamolybdate.

Other required components and optional promoters of the catalyst, (e.g. Ni, Co, Mg, Cr, P, Sn, Te, B, Ge, Zn, In, Ca, W, or mixtures thereof) may be derived from any suitable source. For example, cobalt, nickel and magnesium may be introduced into the catalyst using nitrate salts. Additionally, magnesium may be introduced into the catalyst as an insoluble carbonate or hydroxide which upon heat treating results in an oxide. Phosphorus may be introduced in the catalyst as an alkaline metal salt or alkaline earth metal salt or the ammonium salt but is preferably introduced as phosphoric acid.

Required and optional alkali components of the catalyst (e.g. Rb, Li, Na, K, Cs, TI, or mixtures thereof) may be introduced into the catalyst as an oxide or as a salt, which upon calcination will yield the oxide. Preferably, salts such as nitrates which are readily available and easily soluble are used as the means of incorporating such elements into the catalyst.

The catalysts are prepared by mixing an aqueous solution of ammonium heptamolybdate with a silica sol to which a slurry containing the compounds, preferably nitrates of the other elements, is added. The solid material is then dried, denitrified and calcined. Preferably the catalyst is spray-dried at a temperature of between 110.degree. C. to 350° C., preferably 110° C. to 250° C., most preferably 110° C. to 180° C. The denitrification temperature may range from 100° C. to 500° C., preferably 250° C. to 450° C. Finally, calcination takes place at a temperature of between 300° C. to 700° C., preferably between 350° C. to 650° C.

The catalysts of the instant invention are useful in ammoxidation processes for the conversion of an olefin selected from the group consisting of propylene, isobutylene or mixtures thereof, to acrylonitrile, methacrylonitrile and mixtures thereof, respectively, by reacting in the vapor phase at an elevated temperature and pressure said olefin with a molecular oxygen containing gas and ammonia in the presence of the catalyst.

Preferably, the ammoxidation reaction is performed in a fluid bed reactor although other types of reactors such as transport line reactors are envisioned. Fluid bed reactors, for the manufacture of acrylonitrile are well known in the prior art. For example, the reactor design set forth in U.S. Pat. No. 3,230,246, herein incorporated by reference, is suitable.

Conditions for the ammoxidation reaction to occur are also well known in the prior art as evidenced by U.S. Pat. Nos. 5,093,299; 4,863,891; 4,767,878 and 4,503,001; herein incorporated by reference. Typically, the ammoxidation process is performed by contacting propylene or isobutylene in the presence of ammonia and oxygen with a fluid bed catalyst at an elevated temperature to produce the acrylonitrile or methacrylonitrile. Any source of oxygen may be employed. For economic reasons, however, it is preferred to use air. The typical molar ratio of the oxygen to olefin in the feed should range from 0.5:1 to 4:1, preferably from 1:1 to 3:1. The molar ratio of ammonia to olefin in the feed in the reaction may vary from between 0.5:1 to 5:1. There is really no upper limit for the ammonia-olefin ratio, but there is generally no reason to exceed a ratio of 5:1 for economic reasons. Preferred feed ratios for the catalyst of the instant invention for the production of acrylonitrile are an ammonia to propylene ratio in the range of 0.9:1 to 1.3:1, and air to propylene ratio of 8.0:1 to 12.0:1.

The reaction is carried out at a temperature of between the ranges of about 260to 600° C., preferred ranges being 310 to 500° C., especially preferred being 350° to 480° C. contact time, although not critical, is generally in the range of 0.1 to 50 seconds, with preference being to a contact time of 1 to 15 seconds.

The products of reaction may be recovered and purified by any of the methods known to those skilled in the art. One such method involves scrubbing the effluent gases from the reactor with cold water or an appropriate solvent to remove the products of the reaction and then purifying the reaction product by distillation.

These catalysts are supported with a sol containing two particles of silica with different average particles sizes, one smaller and one larger in relation to each other. The catalysts comprise lesser amounts of the smaller size silica particles and greater amounts of the larger size silica particles. These catalysts are obtained by mixing silica sols of two different size particles of silica. The larger size silica particles have an average particle size that can vary from about 15 to about 75 nm, and the smaller size silica particles have an average particle size that can vary from about 5 to about 20 nm. Preferably, the larger size silica particles have an average particle size of between about 20 to about 50 nm, and the smaller size silica particles have an average particle size of between about 6 to about 15 nm. The preferred range of the large size silica particle is about 80 to about 98 weight percent of the catalyst, and the preferred range of the small size silica particle is about 2 to about 20 weight percent of the catalyst. The weight percent of silica in the final catalyst (active phase +sol) can vary from about 10 to about 70 weight percent. Preferably, the weight percent of silica in the final catalyst (active phase +sol) is about 20 to about 50 weight percent.

The catalysts of this invention are used in partial oxidation of olefins, paraffins, diolefins, and unsaturated aldehydes to useful products such as unsaturated acids and nitriles. These include the conversion of propylene to acrolein and acrylonitrile, propane to acrylonitrile and acrylic acid, acrolein to acrylic acid, and isobutylene to methacrylonitrile.

### EXAMPLE

A promoted bismuth molybdenum oxide based fluid bed oxidation catalyst, supported with silica, of the type described in U.S. Pat. No. 4,212,766, was made using a silica sol with two different sized (one larger and one smaller relative to the other) silica particles. The larger particle had an average particle size of 21 nm, and the smaller particle had an average particle size of 8 nm. The catalyst contained 50 weight percent of the desired active phase and 50 weight percent of silica sol. Several catalyst charges were then made of the same active phase composition, while silica sol was changed by partially substituting varying amounts of the 8 nm silica sol for the 21 nm silica sol.

These catalysts were evaluated for the ammoxidation of propylene to acrylonitrile in the bench scale fluid reactor. There was very little, if any, change in the catalytic activity between the various samples tested.

The following table discloses that when using the mixed sol, the attrition of the catalyst is decreased when the density of the catalyst is increased.

TABLE 1

| | | | | Attrition |
|---|---|---|---|---|
| | | Apparent | Compacted | during |
| 21 nm silica | 8 nm silica | Bulk Density | Bulk Density | 5-20 |
| sol (weight %) | sol (weight %) | (gm/cc) | (gm/cc) | hours (%) |
| 50.0 | 0 | 0.914 | 1.081 | 8.8 |
| 47.5 | 2.5 | 0.924 | 1.067 | 4.7 |
| 45.0 | 5.0 | 0.946 | 1.099 | 3.8 |
| 42.5 | 7.5 | 0.956 | 1.110 | 2.8 |
| 40.0 | 10.0 | 0.941 | 1.131 | 3.6 |
| 35.0 | 15.0 | 0.960 | 1.137 | 2.9 |

The improved density and attrition resistance of the mixed sol is applicable to all fluid bed catalysts and their supports; in particular, they are useful to vapor phase oxidation and ammoxidation catalysts of olefins and paraffins in a fluid bed reactor.

That which is claimed is:

1. A catalyst composition for the oxidation and ammoxidation of hydrocarbons comprising:
a. a plurality of silica sol particles with different average particle sizes; and
b. a complex of metal catalytic oxides having the following formulae:
AₐB_{b}C_{c}Bi_{d}MOₑOₓ, wherein (i)
A is one or more of Li, Na, K, Cs, Rb, In, and TI
B is one or more of Ni, Mn, Co, Mg, Ca, and Zn
C is one or more of Fe, Cr, Ce, Cu, V, W, Sb, Sn, Ge, P, B, Ga, Te, Nb, and Ta,
a is 0.0-1.0
b is 0.0-12.0
c is 1.0-12.0
d is 0.0-2.0
e is 12.0-14.0; or
AₐB_{b}Sb₁₂Oₓ, wherein (ii)
A is one or more of Fe, Cr, Ce, V, U, Sn, Ti, Ga, and Nb
B is one or more of Mo, W, Co, Cu, Te, Bi, Ni, Ca, and Ta
a is 0.1-16
b is 0.0-12.0, and
in both (i) and (ii), the value of x depends on the oxidation state of the metals used.

2. The catalyst of claim 1 wherein said silica sol particles comprise 10 to 70 weight percent of the catalyst composition.

3. The catalyst of claim 2 wherein said silica sol particles comprise 20 to 50 weight percent of the catalyst composition.

4. The catalyst of claim 1 wherein said plurality of silica sol particles comprises at least two silica sol particles, one larger and one smaller relative to the other.

5. The catalyst of claim 4 wherein said larger particle has an average particle size of between about 15 nm to about 75 nm.

6. The catalyst of claim 4 wherein said smaller particle has an average particle size of between about 5 nm to about 20 nm.

7. The catalyst of claim 5 wherein said larger particle has an average particle size of between about 20 nm to about 50 nm.

8. The catalyst of claim 6 wherein said smaller particle has an average particle size of between about 6 nm to about 16 nm.

9. The catalyst of claim 1 wherein A of (i) is selected from the group consisting of Li, K, Cs, TI, or mixtures thereof.

10. The catalyst of claim 1 wherein B of (i) is selected from the group consisting of Ni, Co, Mg, Mn, or mixtures thereof.

11. The catalyst of claim 1 wherein C of (i) is selected from the group consisting of Fe, Cr, Ce, Sn, P, Cu, Sb, V, W, or mixtures thereof.

12. The catalyst of claim 1 wherein A of (ii) is selected from the group consisting of Fe, V, Cr, Ti, Sn, Nb, or mixtures thereof.

13. The catalyst of claim 1 wherein B of (ii) is selected from the group consisting of Cu, Mo, W, Te, or mixtures thereof.

14. A process for producing an ammoxidation catalyst comprising mixing an aqueous slurry of a plurality of silica sol particles having different average particle sizes and a complex of metal catalytic oxides wherein said metal is selected from the group consisting of: Li, Na, K, Cs, Rb, In, TI, Ni, Mn, Co, Mg, Ca, Zn, Fe, Cr, Ce, Cu, V, W, Sb, Sn, Ge, P, B, Ga, Te, Nb, Ta, U, Ti, Mo, W, and Bi; drying and calcining said mixture to produce said ammoxidation catalyst.

15. The process of claim 14 wherein said silica sol particles comprise 10 to 70 weight percent of said ammoxidation catalyst.

16. The catalyst of claim 14 wherein said silica sol particles comprise 20 to 50 weight percent of said ammoxidation catalyst.

17. The process of claim 14 wherein said metal catalytic oxides comprise the following formulae:
AₐB_{b}C_{c}Bi_{d}MOₑOₓ, wherein (i)
A is one or more of Li, Na, K, Cs, Rb, In, and TI
B is one or more of Ni, Mn, Co, Mg, Ca, and Zn
C is one or more of Fe, Cr, Ce, Cu, V, W, Sb, Sn, Ge, P, B, Ga, Te, Nb, and Ta,
a is 0.0-1.0
b is 0.0-12.0
c is 1.0-12.0
d is 0.0-2.0
e is 12.0-14.0; or
AₐB_{b}Sb₁₂Oₓ, wherein (ii)
A is one or more of Fe, Cr, Ce, V, U, Sn, Ti, Ga, and Nb
B is one or more of Mo, W, Co, Cu, Te, Bi, Ni, Ca, and Ta
a is 0.1-16
b is 0.0-12.0, and
in both (i) and (ii), the value of x depends on the oxidation state of the metals used.

18. The process of claim 14 wherein said plurality of silica sol particles comprises two particles, one larger and one smaller in relation to each other.

19. The process of claim 18 wherein said larger particle has an average particle size of between about 15 nm to about 75 nm.

20. The catalyst of claim 18 wherein said smaller particle has an average particle size of between about 5 nm to about 20 nm.

21. The catalyst of claim 19 wherein said larger particle has an average particle size of between about 20 nm to about 50 nm.

22. The catalyst of claim 20 wherein said smaller particle has an average particle size of between about 6 nm to about 16 nm.
